(19) United States
(12) Patent Application Publication
(10) Pub. No.: US 2012/0103159 A1
(43) Pub. Date: May 3, 2012

(54) CUTTING APPARATUS

(76) Inventor: Tony LIN, Taichung City (TW)

(21) Appl. No.: 12/914,553

(22) Filed: Oct. 28, 2010

(51) Int. Cl. B26D 5/12; B26D 7/24

(52) U.S. Cl. 83/620; 83/639.1

(57) ABSTRACT

A cutting apparatus of the present invention mainly includes a cylinder, a cutting assembly and a valve assembly. The valve assembly is connected to the cylinder so as to control action of the cylinder. The cutting assembly is connected to the cylinder, so that the cutting assembly can be driven to cutting plates or boards. The valve assembly has a first switch and a second switch. When both of the first switch and the second switch are turned on, the cutting assembly is driven to move for cutting. When one of the first switch and the second switch is turned off, the cutting assembly is driven to return its initial position.

As such, the first switch is provided for ordinary operation. The second switch is taken as an emergency switch for particular situation so as to avoid accident.

### BACKGROUND OF THE INVENTION

1. Field of the Invention

The present invention relates to a cutting apparatus, more particular to a metal cutting machine.

2. Description of the Prior Art

Pneumatic cylinder is used for driving cutting apparatus. User can operate the cutting apparatus with pressurized air. Pneumatic cylinder is able to drive cutter to move so as to pinch a board off. In such cutting apparatus, a switch is provided for controlling pneumatic cylinder or pressurized air supplies. The force provided by the cylinder is large enough to get users injured. To avoid accident, safety device for emergency stop should be provided for users.

The present invention is, therefore, arisen to obviate or at least mitigate the above mentioned disadvantages.

### SUMMARY OF THE INVENTION

The main object of the present invention is to provide a cutting apparatus with safety device for emergency stop.

To achieve the above and other objects, a cutting apparatus of the present invention includes a base, a cylinder, a cutting assembly, a pressurized air inlet and a valve assembly.

The base has a working surface.

The cylinder includes a fixation portion and a movable portion. The first chamber and a second chamber are defined by the fixation portion and the movable portion. The movable portion is movable with respect to the fixation portion between a first position and a second position. The fixation portion is firmly disposed on the base.

Volume of the first chamber is smaller in size and volume of the second chamber is larger in size when the movable portion moves toward the first position. Volume of the first chamber is larger in size and volume of the second chamber is smaller in size when the movable portion moves toward the second position.

The cutting assembly has a cutting edge. The cutting assembly and the movable portion are in an operative relationship. The cutting edge moves close to the working surface when the movable portion moves toward the first position. The cutting edge moves away from the working surface when the movable portion moves toward the second position.

The pressurized air inlet is adapted for pressurized air to influx therein.

The valve assembly is connected with the first chamber, the second chamber and the pressurized air inlet. The valve assembly includes a first switch and a second switch. The first switch and the second switch are able to be changed between their open positions and their close positions. The first switch has a tendency to move toward its close position.

The valve assembly is used for leading pressurized air from the pressurized air inlet to the second chamber when each of the first switch and the second switch are located at their open positions so as to move the movable portion toward the first position.

The valve assembly is used for leading pressurize air from the pressurized air inlet to the first chamber when one of the first switch and the second switch is located at its close position so as to move the movable portion toward the second position.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a combination drawing showing a prefered embodiment of the present invention;

FIG. 2 is a breakdown drawing showing a prefered embodiment of the present invention;

FIG. 3 is a pneumatic schematic diagram showing a prefered embodiment of the present invention.

### DETAILED DESCRIPTION OF THE PREFERRED EMBODIMENTS

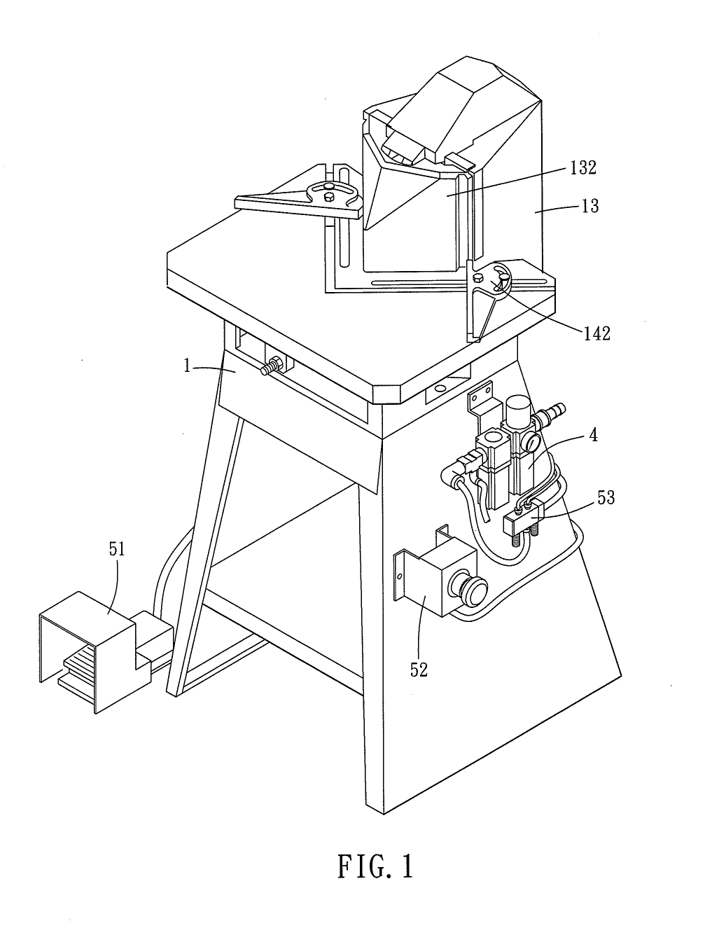

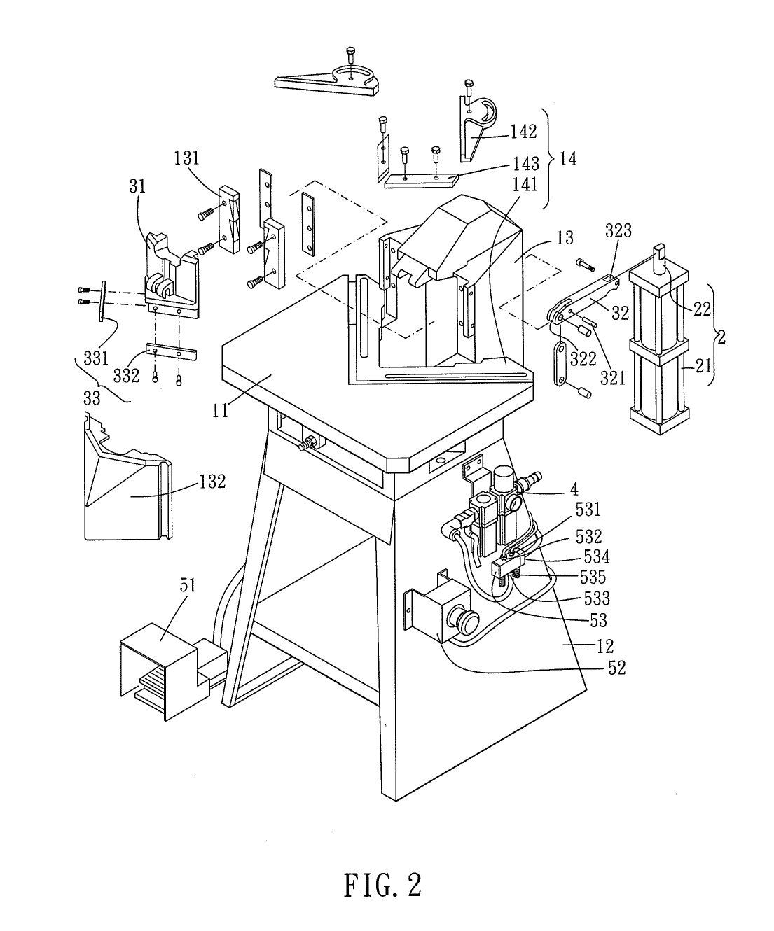

Please refer to FIG. 1 to FIG. 3 for a prefered embodiment of the present invention. The cutting apparatus of the present embodiment is provided for cutting or pinching metal boards. The cutting apparatus includes a base 1, a cylinder 2, a cutting assembly, a pressurized air inlet 4 and a valve assembly.

The base 1 has a working surface 11 and a track. More particularly, the base may includes a supporting portion 12, a working portion 13 and a positioning portion 14. The supporting portion 12 is able to stand on the ground. The working portion 13 is firmly disposed on the supporting portion 12. The working portion 13 includes two pieces 131. The pieces 131 are parallel to each other so as to defining the track. Preferably, the working portion 13 further includes a protecting cover 132. The track is enclosed by the protecting cover 132. The positioning portion 14 is firmly disposed on the working portion 13. The working surface 11 is defined by the positioning portion 14, so that workpieces can be placed or fixed on the working surface 11. The positioning portion 14 may includes a plate 141, two positioning assemblies 142 and a cutter 143. The plate 141 is firmly disposed on the working portion 13. The positioning assemblies 142 are movably disposed on the plate 141. The positioning assemblies 142 are used for positioning or fixing workpieces. The cutter 143 is detachably disposed on the plate 141. The cutter 143 includes two blades perpendicular to each other.

The cylinder 2 includes a fixation portion 21 and movable portion 22. The fixation portion 21 is firmly disposed on the base 1. The movable portion 22 is movably disposed on the fixation portion 21. The cylinder 2 can be controlled by pressurized air so as to drive the movable portion 22 to move between a first position and a second position.

The cutting assembly has a cutting edge. The cutting assembly and the movable portion 22 are in an operative relationship. The cutting edge moves close to the working surface 11 when the movable portion 22 moves toward the first position. On the contrary, the cutting edge moves away from the working surface 11 when the movable portion 22 moves toward the second position. More particularly, the cutting assembly includes a cutter holder 31, a lever 32 and a cutter 33. The cutter holder 31 is slidably disposed on the track. The lever 32 has a lever shaft 321. The lever shaft 321 is disposed on the working portion 13. The lever 32 is able to rotate about the lever shaft 321 with respect to the base 1. The lever 32 has two ends 322 and 323. One end 322 and the cutter holder 31 are in an operative relationship. The other end 323 and the movable portion 22 are in an operative relationship. As such, by the lever 32, the movable portion 22 is able to drive the cutter holder 31 to move along the track. The cutter 33 is firmly disposed on the cutter holder 31, so that the cutter 33 is able to move with the cutter holder 31. The cutting edge is defined by the cutter 33. Preferably, the cutter includes two blades 331 and 332. The blades 331 and 332 are perpendicular to each other.

The pressurized air inlet 4 is adapted for pressurized air to influx therein. The pressurized air inlet 4 may include a pipe or a valve so as to be connected with pressurized air supplies.

The valve assembly is connected between the cylinder 2 and the pressurized air inlet 4, so that the valve assembly is able to control the movement of the movable portion 22. The valve assembly includes a first switch 51 and a second switch 52. The first switch 51 and the second switch 52 are able to be changed between their open position and their close position. In practice, the first switch 51 is a pedal assembly. The first switch 51 may be assembled with an elastic member, so that the first switch 51 has a tendency to move toward its close position. In other practical example, the tendency may be provided by pressurized air. The second switch 52 is an emergency button. Preferably, the second switch 52 is firmly disposed on the base 1. Users can change the second switch between its open position and its close position with one hand.

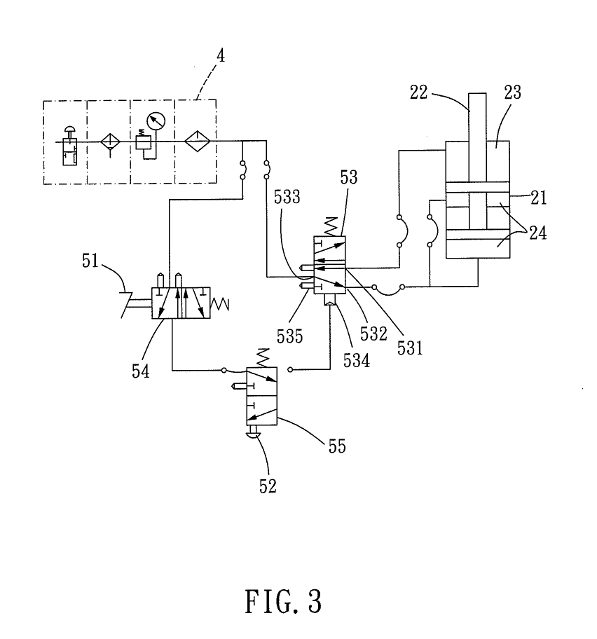

Please refer to FIG. 3. More particularly, a first chamber 23 and a second chamber 24 are defined by the fixation portion 21 and the movable portion 22. The second chamber 24 may be further partitioned by the movable portion 22 into two sub-chambers. When the movable portion 22 moves toward the first position, volume of the first chamber 23 is smaller in size and volume of the second chamber 24 is larger in size. On the contrary, when the movable portion 22 moves toward the second position, volume of the first chamber 23 is larger in size and volume of the second chamber 24 is smaller in size. The valve assembly is connected with the first chamber 23, the second chamber 24 and the pressurized air inlet 4. When each of the first switch 51 and the second switch 52 are located at their open positions, the valve assembly can lead pressurized air from the pressurized air inlet 4 into the second chamber 24. As such, the movable portion 22 is moved toward the first position. On the contrary, when one of the first switch 51 and the second switch 52 is located at its close position, the valve assembly can lead pressurized air from the pressurized air inlet 4 into the first chamber 23. As such, the movable portion 22 is moved toward the second position.

The valve assembly may include a connection valve 53, an operation valve 54 and a safety valve 55. The connection valve 53 has a first opening 531, a second opening 532, a third opening 533 and a controlling portion 534. The first opening 531 communicates with the first chamber 23. The second opening 532 communicates with the second chamber 24. The third opening 533 communicates with the pressurized air inlet 4. The controlling portion 534 is adapted for pressurized air to apply pressure thereon. The first switch 51 is disposed on the operation valve 54 so as to control the operation valve 54. In other words, the operation valve 54 is closed when the first switch is closed. Similarly, the second switch 52 is disposed on the safety valve 55 so as to control the safety valve 55. The operation valve 54 and the safety valve 55 are series connected between the pressurized air inlet 4 and the controlling portion 534. As such, communicating status between the first opening 531, the second opening 532 and the third opening 533 is controlled by the operation valve 54 and the safety valve 55. More particularly, the controlling portion 534 is pressurized when each of the operation valve 54 and the safety valve 55 is opened. The second opening 532 communicates with the third opening 533. The first opening 531 may communicate with surroundings via an opening 535 so as to release air. On the contrary, the controlling portion 534 is released from pressurized air when one of the operation valve 54 and the safety valve 55 is closed. The first opening 531 communicates with the third opening 533. The second opening 532 may communicate with surroundings via an opening 535 so as to release air. Preferably, a silencer may be disposed on the opening 535 so as to reduce noise made by air flowing.

Accordingly, the cutting apparatus is provided for cutting plates or boards. Users can open the second switch 52, operating the cutting apparatus with the first switch 51, a pedal assembly, for ordinary operation. Users can push the second switch 52, an emergency button, in particular situations. The movable portion of the cylinder is driven toward the second position so as to keep the cutting edge away from the working surface. As such, users can escape from the cutting edge to avoid injury caused by the cutting assembly.

What is claimed is:

1. A cutting apparatus, comprising:
a base, having a working surface;
a cylinder, comprising a fixation portion and a movable portion, a first chamber and a second chamber being defined by the fixation portion and the movable portion, the movable portion being movable with respect to the fixation portion between a first position and a second position, the fixation portion being firmly disposed on the base;
wherein a volume of the first chamber is smaller in size and a volume of the second chamber is larger in size when the movable portion moves toward the first position;
wherein the volume of the first chamber is larger in size and the volume of the second chamber is smaller in size when the movable portion moves toward the second position;
a cutting assembly, having a cutting edge, the cutting assembly and the movable portion being in an operative relationship, the cutting edge moving close to the working surface when the movable portion moves toward the first position, the cutting edge moving away from the working surface when the movable portion moves toward the second position;
a pressurized air inlet, being adapted for pressurized air to influx therein;
a valve assembly, connected with the first chamber, the second chamber and the pressurized air inlet, the valve assembly comprising a first switch and a second switch, the first switch and the second switch being able to be changed between their open positions and their close positions;
wherein the valve assembly is used for leading pressurized air from the pressurized air inlet to the second chamber when each of the first switch and the second switch are located at their open positions, so that the movable portion moves toward the first position;
wherein the valve assembly is used for leading pressurize air from the pressurized air inlet to the first chamber when one of the first switch and the second switch is located at its close position, so that the movable portion moves toward the second position;
wherein the first switch has a tendency to move toward its close position.

2. The cutting apparatus of claim 1, wherein the valve assembly comprises a connection valve, an operation valve and a safety valve, the connection valve has a first opening, a second opening, a third opening and a controlling portion, the first opening communicates with the first chamber, the second opening communicates with the second chamber, the third opening communicates with the pressurized air inlet, the first switch is disposed on the operation valve so as to control the operation valve, the second switch is disposed on the safety valve so as to control the safety valve, the operation valve and the safety valve are series connected between the pressurized air inlet and the controlling portion, the controlling portion is adapted for pressurized air to apply pressure thereon, the second opening communicates with the third opening when the controlling portion is pressurized, the first opening communicates with the third opening when the controlling portion is released from pressurized air.

3. The cutting apparatus of claim 1, wherein the base has a track, the cutting assembly comprises a cutter holder, a lever and at least a cutter, the cutter holder is slidably disposed on the track, the lever is disposed on the base, the lever is able to rotate with respect to the base, the lever has two ends, one end and the cutter holder are in an operative relationship, the other end and the movable portion are in an operative relationship, so that the movable portion is able to drive the cutter holder to move along the track, the cutter is firmly disposed on the cutter holder, the cutter is able to move with the cutter holder, the cutting edge is defined by the cutter.

4. The cutting apparatus of claim 2, wherein the base has a track, the cutting assembly comprises a cutter holder, a lever and at least a cutter, the cutter holder is slidably disposed on the track, the lever is disposed on the base, the lever is able to rotate with respect to the base, the lever has two ends, one end and the cutter holder are in an operative relationship, the other end and the movable portion are in an operative relationship, so that the movable portion is able to drive the cutter holder to move along the track, the cutter is firmly disposed on the cutter holder, the cutter is able to move with the cutter holder, the cutting edge is defined by the cutter.

5. The cutting apparatus of claim 3, wherein the cutter comprises two blades, the blades are perpendicular to each other.

6. The cutting apparatus of claim 4, wherein the cutter comprises two blades, the blades are perpendicular to each other.

7. The cutting apparatus of claim 1, wherein the first switch is a pedal assembly, the second switch is an emergency button, the second switch is firmly disposed on the base.

8. The cutting apparatus of claim 2, wherein the first switch is a pedal assembly, the second switch is an emergency button, the second switch is firmly disposed on the base.
